(19) United States
(12) Patent Application Publication
(10) Pub. No.: US 2006/0186032 A1
(43) Pub. Date: Aug. 24, 2006

(54) Modular fluid processing system with reversible plumbing connection

(76) Inventors: John Michael Camilli, Ventura, CA (US); David Michael Fallera, Ventura, CA (US)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/063,528

(22) Filed: Feb. 24, 2005

(51) Int. Cl. B01D 63/00

(52) U.S. Cl. 210/321.6; 210/322; 210/541; 210/407; 210/321.72; 210/321.83; 285/18

(57) ABSTRACT

A modular fluid processing system with at least one module comprising a frame and at least two housings, each housing having an interior configured to contain at least one fluid separation element; and at least one plumbing assembly with connection ports configured to connect in fluid communication with the interiors of the at least two housings in a first orientation and a second orientation. The at least one plumbing assembly is reversible in that the second orientation is substantially a 180° rotation of the first orientation. An embodiment of the fluid processing system can have a first module including a frame and at least two housings with interiors configured to contain at least one fluid separation element; at least another module including a frame connectable to the frame of the first module, at least one housing, the at least one housing having an interior configured to contain at least one fluid separation element; and at least one plumbing assembly configured to connect in fluid communication with the interiors of the at least two housings of the first module and the at least one housing of the second module.

### FIELD OF INVENTION

The present invention relates to a fluid treatment system and process designed to easily allow installation, maintenance and plumbing via use of a modular assembly. The modular assembly is equipped with reversible inlet and outlets, thus allowing simple assembly in either a right-hand or left-hand configuration.

### BACKGROUND

Fluid separation is required in many commercial enterprises such as the chemical, foodstuffs, electronics, coatings, power industry, and pharmaceutical industries. Typically these applications require treatment of a feed flow (such as effluent from a coating process or water from a municipal water supply) to reduce the level of contaminants or to divide the feed flow into two separate streams with different properties. These treatment techniques can include distillation, filtration, adsorption, ultrafiltration, nanofiltration, reverse osmosis, ion exchange, photo-oxidation, ozonation, and combinations thereof. For example, electrocoat paint processes can use, among other techniques, ultrafiltration in order to separate a feed paint stream into a paint-out stream (“retentate”) and a permeate stream.

When fluid separation elements such as reverse-osmosis membranes, micro-filters, ultra-filters, or nano-filters are used, the purification elements must be enclosed inside housings in order to properly direct fluid flow over the surface or surfaces of the fluid separation element. Such housings are often made from plastic, stainless steel, fiberglass or similar materials. The housings typically have at least one inlet port for the feed and one outlet port.

Unlike conventional flow-through filters, cross-flow fluid separation elements such as R.O., ultra-filters, and nano-filters divide a feed stream into two separate output streams; a concentrated stream (“retentate”) and a purified stream (“permeate”). The retentate stream contains more of some type of dissolved solid or fluid than did the original feed fluid, and the permeate contains less. Accordingly, housings used in cross-flow fluid separation have three ports, one each for the feed, retentate stream, and permeate.

An electrocoat paint process provides a good example of the use of the above-discussed fluid separation technologies implemented in an industrial process. Electrocoat paint is made up of water, pigments, resins, film-formers, solvents and other proprietary components. A manufactured part is coated with the electrocoat paint by submerging the manufactured part in a paint bath. After coating, the manufactured part is rinsed with water and solvent (permeate) to remove excess paint. The rinse process results in a mix of the water, solvent, and paint. The above-discussed filtration processes are used to separate the permeate from the paint for this rinsing process.

After separation from the mixture followed by rinsing, the permeate, now laden with paint solids, can be returned to the paint bath in a manner that helps establish circulation patterns conducive to healthy paint chemistry while at the same time recapturing and returning costly paint solids to the paint tank. Both the retentate and the permeate return to re-incorporate into the paint bath.

The feed flow rate provided to a cross-flow fluid separation element is normally higher than either the permeate or the retentate flow rates. This is because mass conservation requires the feed flow rate to equal the sum of the retentate and permeate flow rates. Therefore, piping carrying the feed, retentate and permeate is often sized differently for each. Thus, the feed, retentate and permeate piping in conventional fluid processing systems is not interchangeable.

Housings for purification elements, whether through-flow or cross-flow, are often supported by a rigid frame. For example, square steel tube, strut, or channel is often welded together to form a support structure for housings, pumps and plumbing. The plumbing and housings are then bolted or clamped to the frame. The orientation of the plumbing and housings on the frame is typically designed for conservation of materials and space. Feed ports are typically placed at one end of the frame; retentate and permeate ports are placed at the other. In conventional fluid processing systems, the arrangement of the feed, retentate, and permeate ports is predetermined at the design stage and cannot easily be modified after assembly. Additionally, it may be necessary to assemble the plumbing in an ordered sequence because other parts of the plumbing and frame may interfere with installation and removal of the feed, retentate and permeate piping. A technician at the facility in which the frame is installed then makes plumbing connections to the frame via custom fabricated piping.

Conventional arrangements of the feed, retentate, and permeate plumbing allow for installation of the plumbing in only a single orientation. More than one configuration is not possible because of interference between the plumbing and parts of the frame, housings or other plumbing.

The customized plumbing configuration depends on the arrangement of the feed, retentate and permeate ports on the frame. The more accessible these ports, the simpler the customized plumbing may be made. However, as conventional equipment provides only a single configuration for the connections between the equipment and the facility, and this configuration must be determined at the design stage, it is difficult to adapt conventional equipment to unforeseen circumstances that may occur upon installation. For example, if the equipment is designed for a retentate connection on the right-hand side of the frame, but other equipment inside the facility obstructs this connection, the retentate connection cannot easily be switched to the left-hand side of the frame.

Additionally, the fluid processing capacity of conventional equipment is not easily expandable. With conventional systems, an increase in the fluid processing requirements of a facility requires either the purchase of a new, larger fluid processing system, or at least the purchase of an additional, self-contained system. When a new, larger system is purchased, the old system is no longer useful and is usually re-sold or taken off-line. When an additional system is purchased to supplement an existing system; new, customized plumbing must be installed at the facility in order to provide fluid connections to the new equipment. Such plumbing occupies more space within the facility and requires expenditures on both labor and material.

### SUMMARY OF THE INVENTION

The inventors have discovered that providing a fluid processing system made with a fluid processing module or modules with plumbing connections capable of orientation in different directions allows easier plumbing of facility piping to the frame. Moreover, the overall horizontal and vertical footprint of the module is smaller compared to conventional systems. Component costs can be reduced because plumbing is more standardized and volume purchasing may be possible. Shipping is less expensive because the module may be partially disassembled before it is sent. Transportation of the fluid processing system is easier because the system as a whole may not fit through doors at the facility where it will be used, but the individual modules may. Additionally, maintenance is easier because the overall construction of the system is simplified and parts are interchangeable. Modification of the system on-site is also easier when a change in fluid flow direction is necessary. After-market sales of the module are also improved because the module can be installed more easily in other facilities where the fluid connections come from a different direction.

In one embodiment, the module can be connected in parallel combinations with other modules. Thus, the fluid processing system is expandable and can be adapted to user's changing needs.

At least some of these benefits may be realized by the present invention. An exemplary embodiment of the present invention includes a modular fluid processing system with at least one frame holding at least two housings. The housings each can hold at least one fluid separation element such as a micro-filter, ultra-filter, nano-filter or other fluid separation elements. A plumbing assembly connects the housings. In one embodiment, the plumbing assembly can be connected on one orientation, or connected in a different orientation that is approximately a 180 degree rotation of the first orientation, i.e., the plumbing assembly is reversible. The reversible plumbing assembly can be the piping for the feed flow, the retentate flow, the permeate flow or any combination of these.

In another embodiment, the modular fluid processing system includes a first module including a frame and at least two housings. Each housing has an interior configured to hold at least one fluid separation element such as a micro-filter, ultrafilter, reverse-osmosis membrane or nanofilter. The system also has at least one additional module including a frame and at least one housing. The at least one housing has an interior configured to hold at least one fluid separation element. The system has at least one plumbing assembly configured to connect in fluid communication with the interiors of the at least two housings of the first module and the at least one housing of the second module.

### BRIEF DESCRIPTION OF THE DRAWINGS

In the accompanying drawings:

FIG. 1 shows a perspective view of a module with two housings installed and a view of the feed, concentrate and permeate plumbing assemblies;

FIG. 2 shows a plan view of a reversible plumbing assembly;

FIG. 3 shows a perspective view of a module with three housings installed and a view of the feed, concentrate and permeate plumbing assemblies;

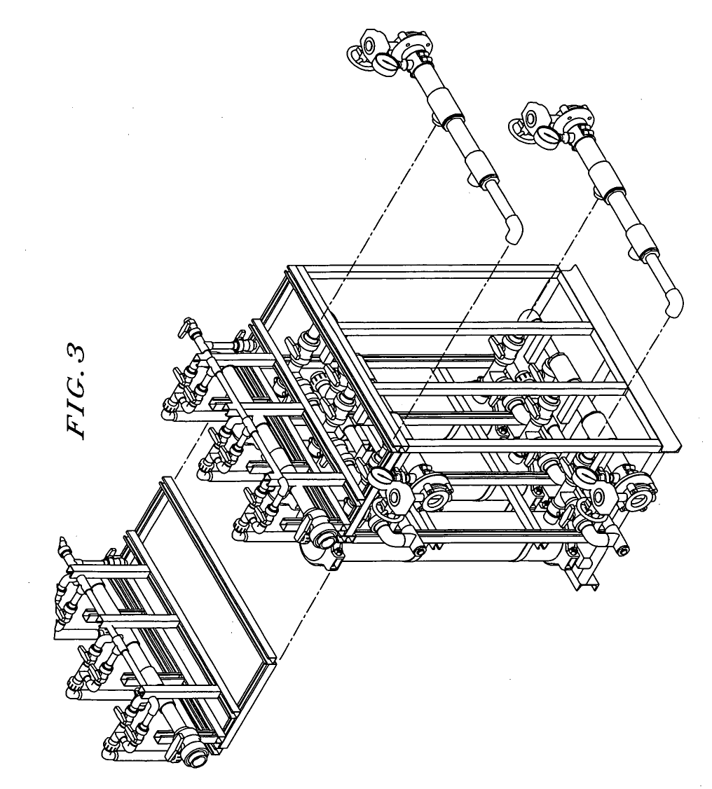

FIG. 4. shows a perspective view of a two modules connected to form a five-housings system;

FIG. 5. shows a perspective view of a detachable cleaning skid;

FIG. 6. shows a two-housing module and a three-housing module first in a separate state, then connected together to form a five-housing fluid processing system;

FIG. 7. shows a close-up of a three-housing module with the permeate assembly installed.

### DETAILED DESCRIPTION OF THE INVENTION

The term fluid separation element, as used herein, refers to a device capable of separating a fluid from a solid or another fluid. The solid may be dissolved or undissolved. Non-limiting examples of fluid separation elements include: reverse-osmosis membranes, micro-filters, ultra-filters, and nano-filters. The filters can be any type of filter material, preferably of hollow fiber type or spiral wound.

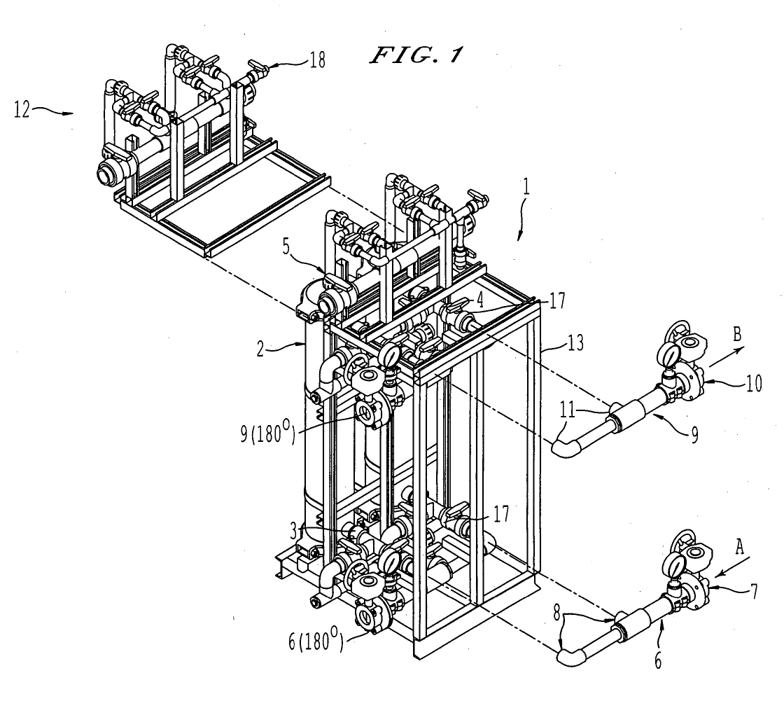

An exemplary embodiment of the invention is shown in FIG. 1. The module is made of a frame 13, housings 2, and associated plumbing.

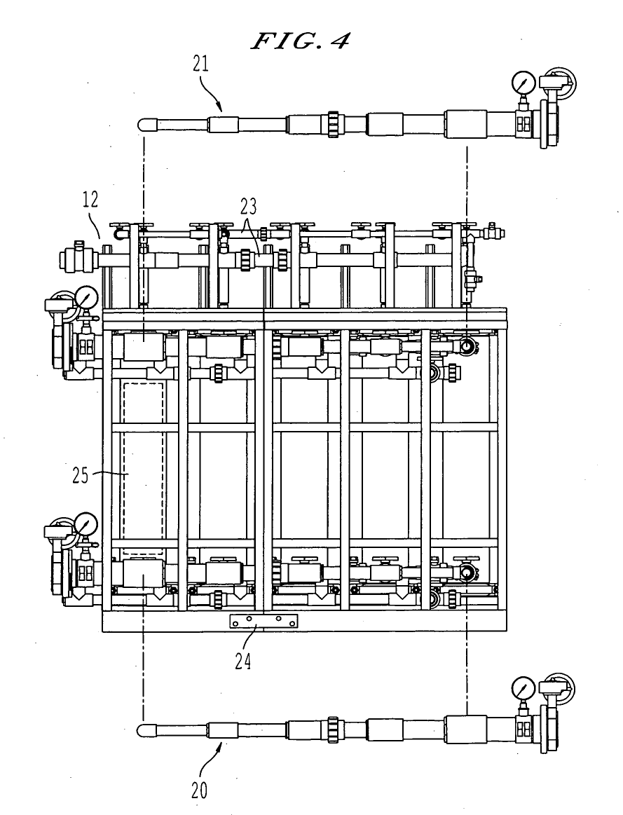

In this particular embodiment, the module 1 holds two housings 2. Other embodiments of the module may hold more housings. Each housing 2 normally contains at least one fluid separation element 25 (FIG. 4), although when the module 1 is first installed, the fluid separation elements may not yet be installed in the housings 2. Additionally, depending on the amount of fluid to be processed, a housing 2 may be left empty while another housing or housings 2 are loaded with fluid separation elements. The empty housing is normally blocked from fluid communication with any loaded housings when the module performs fluid processing. The empty housing can be put into use as needed, such as when one of the fluid separation elements in another housing must be replaced, regenerated or repaired. This allows for uninterrupted processing in the unit. Each housing has at least one input port 3 and at least one output port 4. The input port 3 allows a fluid feed flow to enter the housing and fluid separation element, and the output port allows fluid to exit the housing 2. Depending on what type of fluid separation element technology is used, a housing 2 may have a third type of fluid port, a permeate port 5, for permeate. In order to save space, the housings are preferably installed in a vertical orientation, i.e. the fluid flows in substantially a vertical direction, but other orientations are possible.

A product-in assembly 6 connects to the housings 2 via housing input ports 3. The product-in assembly 6 has an input inlet 7 and inlet distribution ports 8 configured to connect the product-in assembly 6 in parallel to the housing input ports 3 on the housings 2. An input inlet 7 connects to the facility plumbing (not shown) supplying fluid to the fluid processing system 1.

Similarly, a retentate assembly 9 connects to the housings 2 via housing output ports 4. The retentate assembly 9 has an retentate output port 10 and multiple retentate collection ports 11 configured to connect the retentate assembly 9 in parallel to the housing output ports 4 on the housings 2. Retentate output port 10 connects to a connection provided at the facility (not shown).

In one embodiment, the plumbing size of the product-in assembly 6 stays constant from the product-in inlet 7 to the opposite end of the product-in assembly. In yet another embodiment, as shown in FIG. 1, the plumbing size of the product-in assembly 6 decreases in the direction of flow arrow A. Such a reduction in plumbing size prevents the fluid velocity inside the plumbing from decreasing across the length of the apparatus. Having a constant, predetermined velocity reduces the potential for paint solids to drop out of solution. When paint solids drop out of solution, the solids can cause plugging of the fluid separation element, thus reducing the over-all life of the fluid separation element used in the system.

Similarly, in the retentate assembly 9, the plumbing size increases in the direction of flow arrow B in order to accommodate the larger amount of fluid inside the retentate assembly 9 as more retentate collection ports 11 contribute to the retentate flow.

In one embodiment, housing port valves 17 are connected to the housing input ports 3 or the housing output ports 4, or both. The valves are typically PVC ball valves, but are not limited to this type. The typical piping material used throughout the system is typically schedule 40 PVC and schedule 80 PVC. However, other materials, including, but not limited to, stainless steel may be used for some or all of the plumbing.

In one exemplary embodiment, product-in assembly 6 and retentate assembly 9 are interchangeable. The dimensions between the ports, the types of connections, and the plumbing material are substantially similar. Such interchangeability allows ease of production of subassemblies during the manufacturing process. As one subassembly serves two purposes, production, inventory control and field service are simplified. Accordingly, throughout this description, any description of the product-in assembly 6 and its sub-parts applies equally to the retentate assembly 9 and its sub-parts, and vice versa unless otherwise stated.

As shown in FIG. 1, the product-in assembly is dimensioned such that it can be attached to the housing input ports 3 in two different orientations. In the first orientation, the product-in inlet 7 points toward the right-hand side of the module 1. In the second orientation, the product-in inlet 7 on the product-in assembly 6(180°) points toward the left-hand side of the module 1. Product-in assemblies 6 and 6(180°) are usually substantially identical except for the 180° rotation. In other words, the product-in assembly 6 can connect to the housing input ports 3 with either a 0° rotation or a 180° rotation. Similarly, the retentate assembly 9 can connect to the housing output ports 4 in either a 0° rotation, or as shown by reference number 9(180°) in FIG. 1, a 180° rotation. Accordingly, the user can arrange the module 1 for connection from either the right-hand or left-hand side as needed.

In one embodiment, the permeate module 12 is also reversible. Thus, all three connections may be changed on-site to accommodate the needs of the facility.

As discussed above, in one embodiment, the product-in assembly 6 and retentate assembly 9 are interchangeable and either assembly may be rotated. Therefore, the module 1 can have the product-in inlet 7 pointed toward the right-hand side of the machine and the retentate output 10 pointed toward the left-hand side of the module 1, or vice versa. Additionally, both the product-in inlet 7 and the retentate output 10 may point in the same direction (toward the right-hand side or left-hand side). Moreover, the orientation of the permeate module 12 is independent of the orientation of the product-in assembly 6 and retentate assembly 9. Thus, the permeate-out port 18 may be directed toward either the right-hand side or left-hand side of the module 1. Therefore, at least eight different plumbing configurations are possible with a single module 1 and single permeate module 12.

The ability to reverse the product-in assembly 6, retentate assembly 9, and permeate module 12 allows installation of the module 1 in configurations adapted to the needs of the facility. The flexible design reduces the need for custom design at the time of receipt of a fluid processing system at a facility because the same module can accommodate either right-hand or left-hand inlet and outlet connections.

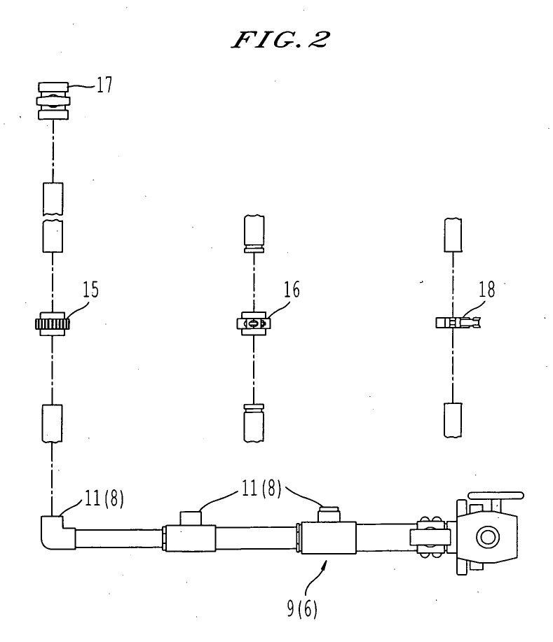

FIG. 2 shows a plan view of a retentate assembly 9(6). In this embodiment, the retentate assembly 9(6) has three retentate collection ports 11 (inlet distribution ports 8). In other embodiments, the number of such ports may differ as the number of retentate collection ports 11 (inlet distribution ports 8) is normally determined by the number of housings 2 on the module 1.

As shown in FIG. 2, the connections between the housing input ports 3 and inlet distribution ports 8; and the connections between the housing output ports 4 and the retentate collection ports 11 are usually made with mechanical coupling devices. Such devices allow the product-in assembly 6 and retentate assembly 9 to be removed by hand or with only a few tools. Non-limiting examples of such mechanical couplings include: threaded unions 15, grooved pipe couplings 16 such as Victaulic® brand couplings, sanitary connections 18, and flanges (not shown). In order to facilitate removal of the couplings, wing-nuts (not shown) may be used in place of standard hex nuts, thus allowing removal of the mechanical couplings without the use of tools.

FIG. 2 also shows the location of valve 17 on the retentate assembly 9 (6). Valves 17 may be connected in-line with some or all of the inlet distribution ports 8 and retentate collection ports 11. Thus, if either the product-in assembly 6 or the retentate assembly 9 needs to be removed, the technician may close the valves 17 in order to prevent leakage from the housings 2. Such an arrangement is useful while the product-in assembly 6 or retentate assembly 9 is rotated 180°, for example. Additionally, the valves may include threaded unions on either end, thus allowing the valves to remain on (seal) the retentate assembly 9(6) or the housings 2 as desired during removal.

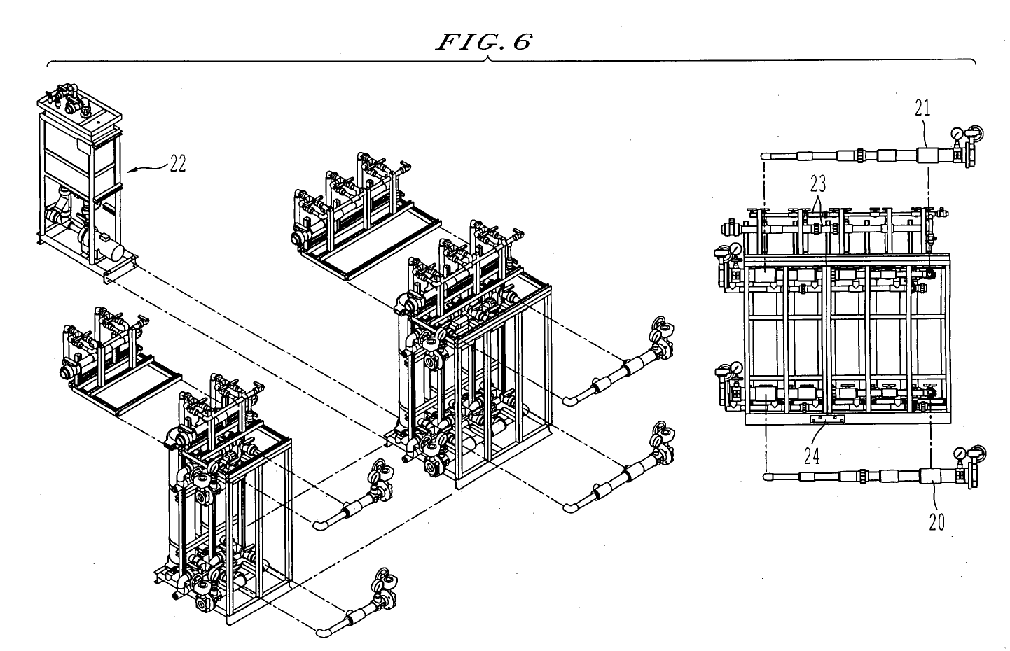

FIG. 4 shows a two-housing module and a three housing module connected via bracket 24. Although only two modules are shown connected in FIG. 4, additional modules may be added as necessary in order to process larger quantities of fluid required by the end-user. FIG. 6 shows how the modules are connected. “Large-product-in” assembly 20 and “large-retentate” assembly 21 have enough inlet distribution ports 8 and retentate collection ports 11, respectively, to connect to the increased number of housings 2. Large-product-in assembly 20 and large-retentate assembly 21 are rotatable for either right-hand or left-hand connections on the combined module as necessary. The permeate modules 12 are also combinable and connect with spools 23. However, it is not necessary to connect the permeate modules 12 in every combination of modules 1.

As shown in FIGS. 4 and 6, the modules attach in a space-saving configuration. In one embodiment, the frames of the modules are connected with bracket 24. In another embodiment, the frames are bolted without the use of a bracket 24. One advantage of the modular system described above that the individual modules can be designed to fit through standard doorways and then connected together inside the facility. Additionally, shipment of the individual modules is easier than with conventional systems because the modules may be shipped in separate crates, or even from different locations, and then assembled on-site.

Another advantage of an exemplary embodiment of the invention is that the capacity of the fluid processing system may be increased as needed without discarding an existing module. The purchase of an additional module will often be less expensive than purchasing an entirely new self-contained system. Additionally, connection of a new module to the facility feed and retentate lines is simpler because the modules are configured to connect to each other via large-product-in assembly 20 and large-retentate assembly 21. Therefore, an installation technician need not create customized plumbing to connect to the facility.

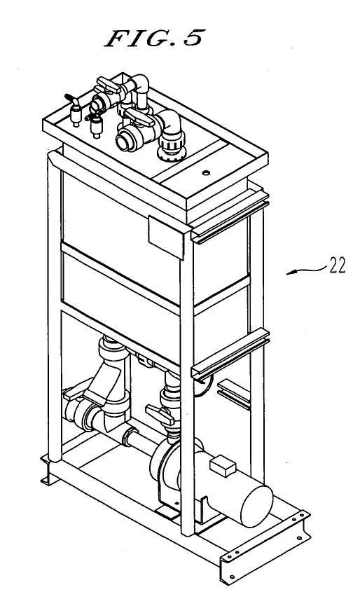

FIG. 5 shows a cleaning apparatus 22. FIG. 6 shows how the cleaning apparatus connects to the module 1. The cleaning apparatus 22 may be detacheably connected to the frame 13 of module 1 via a bracket, bolts or similar hardware. When the cleaning apparatus is attached to the frame 13, space is conserved. The cleaning apparatus 22 may be detached from the frame 13 as necessary for shipping, service or replacement. Additionally, the cleaning apparatus may be detached and used to clean other modules or equipment in other parts of the facility. Typically, the cleaning module is attached to the machine on the side of module 1 opposite product-in assembly 6 and retentate assembly 9 connections. This design allows the cleaning module 22 to be put on either side of the module 1, even after the equipment has been manufactured.

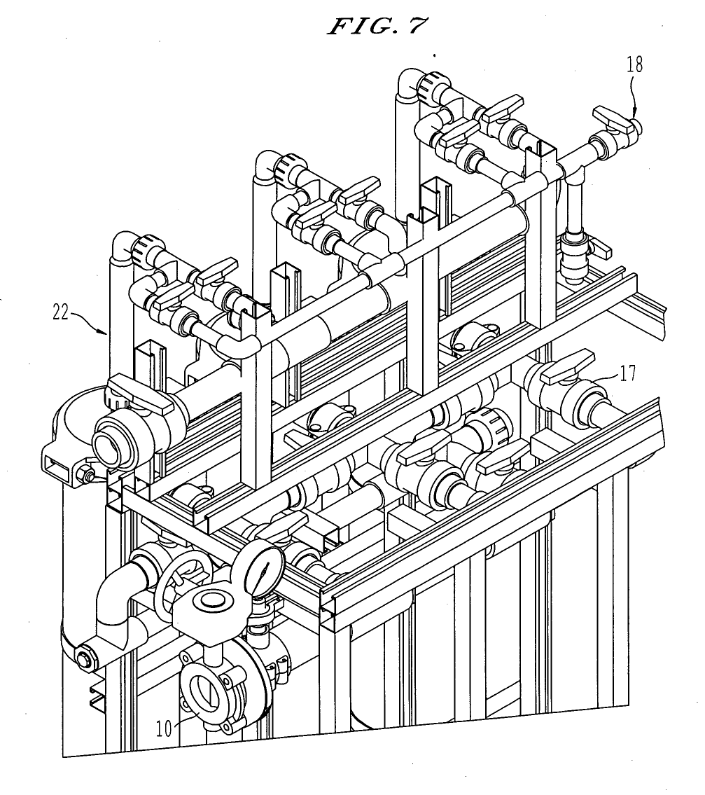

FIG. 7 shows a close-up view of the top of a module 1 with a permeate module 12 installed. In this non-limiting example, the permeate port 18 points toward the right-hand side of the frame 13. The retentate output port 10 points toward the left-hand side of the frame 13 in this embodiment. However, as discussed above, any combination of arrangements of the product-in assembly 6, retentate assembly 9 and permeate assembly 12 are possible.

Housing port valve 17 is depicted in FIG. 7 in the closed position. During operation, any housing port valve 17 connected to a housing 2 active in the fluid separation process would be in an open position.

Accordingly, a modular fluid processing system with reversible plumbing connection is provided that reduces at least some of the mentioned disadvantages of conventional fluid processing machines. Although only certain embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

1. A modular fluid processing system comprising:
at least one module comprising a frame and at least two housings, each housing having an interior configured to contain at least one fluid separation element; and
at least one plumbing assembly with connection ports configured to connect in fluid communication with the interiors of the at least two housings in a first orientation and a second orientation.

2. The modular fluid processing system of claim 1, wherein the at least one plumbing assembly includes an input plumbing assembly.

3. The modular fluid processing system of claim 1, wherein the at least one plumbing assembly includes an output plumbing assembly.

4. The modular fluid processing system of claim 1, wherein the at least one plumbing assembly includes an output plumbing assembly and an input plumbing assembly.

5. The modular fluid processing system of claim 4, wherein the output plumbing assembly and the input plumbing assembly are interchangeable.

6. The modular fluid processing system of claim 1, wherein the at least one plumbing assembly includes a permeate plumbing assembly.

7. The modular fluid processing system of claim 1, wherein the at least one plumbing assembly is configured to connect the at least two housings in parallel fluid communication.

8. The modular fluid processing system of claim 1, wherein the second orientation of the at least one plumbing assembly is substantially similar to the first orientation rotated approximately 180 degrees about an axis.

9. The modular fluid processing system of claim 1, wherein the connection ports of the at least one plumbing assembly are configured to connect to the at least two housings with mechanical couplings.

10. The modular fluid processing system of claim 9, wherein the mechanical couplings are threaded unions.

11. The modular fluid processing system of claim 9, wherein the mechanical couplings are grooved couplings.

12. The modular fluid processing system of claim 9, wherein the mechanical couplings are sanitary connections.

13. The modular fluid processing system of claim 1 further comprising detachable cleaning equipment.

14. The modular fluid processing system of claim 13, wherein the detachable cleaning equipment can be attached to either the left side or the right side of the module as viewed from the side of the module connected to the at least one plumbing assembly.

15. The modular fluid processing system of claim 1, wherein the module is configured to connect in fluid communication with another module via the at least one plumbing assembly.

16. The modular fluid processing system of claim 1, further comprising the at least one fluid separation element.

17. The modular fluid processing system of claim 16, wherein the at least one fluid separation element is of a cross-flow type.

18. The modular fluid processing system of claim 16, wherein the at least one fluid separation element is a microfilter.

19. The modular fluid processing system of claim 16, wherein the at least one fluid separation element is an ultra-filter.

20. The modular fluid processing system of claim 16, wherein the at least one fluid separation element is a nano-filter.

21. The modular fluid processing system of claim 16, wherein the at least one fluid separation element is a reverse-osmosis membrane.

22. The modular fluid processing system of claim 16, wherein the at least one fluid separation element is a hollow-fiber element.

23. The modular fluid processing system of claim 16, wherein the at least one fluid separation element is a spiral wound element.

24. The modular fluid processing system of claim 1, wherein the housings are oriented such that fluid inside the housing flows substantially in a vertical direction.

25. The modular fluid processing system of claim 1, wherein the at least two housings comprise three housings.

26. The modular fluid processing system of claim 1, wherein the at least two housings comprise five housings.

27. A modular fluid processing system comprising:
at least two fluid separation means;
a means for holding the at least two fluid separation means; and
a reversible means for connecting in parallel fluid communication the at least two fluid separation means.

28. The modular fluid processing system of claim 27, further comprising a detachable cleaning means.

29. The modular fluid processing system of claim 27, wherein the means for holding the at least two fluid separation means is oriented is oriented such that fluid inside the means flows in substantially a vertical direction.

30. A modular fluid processing system comprising:
a first module including a frame and at least two housings, each housing having an interior configured to contain at least one fluid separation element;
at least a second module including a frame configured to detachably connect to the frame of the first module, at least one housing, the at least one housing having an interior configured to contain at least one fluid separation element; and
at least one plumbing assembly configured to connect in fluid communication with the interiors of the at least two housings of the first module and the at least one housing of the second module.

31. The modular fluid processing system of claim 30, further comprising at least a third module comprising at least one housing, the housing having an interior configured to contain at least one fluid separation element,
wherein the at least one plumbing assembly is configured to further connect in fluid communication with the interior of the at least one housing of the at least third module.

32. The modular fluid processing system of claim 30, wherein the at least one plumbing assembly is configured to connect to the at least two housings of the first module and the at least one housing of the second module in a first orientation and in a second orientation.

33. The modular fluid processing system of claim 32, wherein the second orientation of the at least one plumbing assembly is substantially similar to the first orientation rotated approximately 180 degrees about an axis.

34. The modular fluid processing system of claim 30, wherein the at least one plumbing assembly includes an input plumbing assembly.

35. The modular fluid processing system of claim 30, wherein the at least one plumbing assembly includes an output plumbing assembly.

36. The modular fluid processing system of claim 30, wherein the at least one plumbing assembly includes an output plumbing assembly and an input plumbing assembly.

37. The modular fluid processing system of claim 36, wherein the output plumbing assembly and the input plumbing assembly are interchangeable.

38. The modular fluid processing system of claim 30, wherein the at least one plumbing assembly includes a permeate plumbing assembly.

39. The modular fluid processing system of claim 30, wherein the at least one plumbing assembly is configured to connect the at least two modules in parallel fluid communication.

40. The modular fluid processing system of claim 30, wherein the at least one plumbing assembly is configured to connect to the at least two housings with a mechanical coupling.

41. The modular fluid processing system of claim 40, wherein the mechanical couplings are threaded unions.

42. The modular fluid processing system of claim 40, wherein the mechanical couplings are grooved pipe couplings.

43. The modular fluid processing system of claim 40, wherein the mechanical couplings are sanitary connections.

44. The modular fluid processing system of claim 40 further comprising detachable cleaning equipment.

45. The modular fluid processing system of claim 44, wherein the detachable cleaning equipment can be attached to either the left side of the right side of the module as viewed from the side of the module connected to the at least one plumbing assembly.

46. The modular fluid processing system of claim 30 further comprising the at least one fluid separation element.

47. The modular fluid processing system of claim 46, wherein the at least one fluid separation element is a cross-flow element.

48. The modular fluid processing system of claim 46, wherein the at least one fluid separation element is a micro-filter.

49. The modular fluid processing system of claim 46, wherein the at least one fluid separation element is an ultra-filter.

50. The modular fluid processing system of claim 46, wherein the at least one fluid separation element is a nano-filter.

51. The modular fluid processing system of claim 46, wherein the at least one fluid separation element is a reverse-osmosis membrane.

52. The modular fluid processing system of claim 46, wherein the at least one fluid separation element is a hollow fiber element.

53. The modular fluid processing system of claim 46, wherein the at least one fluid separation element is a spiral wound element.
